(19) United States
(12) Patent Application Publication
(10) Pub. No.: US 2007/0025601 A1
(43) Pub. Date: Feb. 1, 2007

(54) Algorithm for rebuilding 1D information into 2D information and 1D skin pattern sensing module thereof

(75) Inventors: Chia-Chu Cheng, Hsin-Tien City (TW); Shr-Bin Wu, Hsin-Tien City (TW)

Correspondence Address: BIRCH STEWART KOLASCH & BIRCH, PO BOX 747, FALLS CHURCH, VA, 22040-0747, US

(73) Assignee: LITE-ON SEMICONDUCTOR CORP.

(21) Appl. No.: 11/411,866

(22) Filed: Apr. 27, 2006

(30) Foreign Application Priority Data
Jul. 26, 2005 (TW) 94125231

(51) Int. Cl. G06K 9/00

(52) U.S. Cl. 382/124

(57) ABSTRACT

An algorithm for rebuilding 1D information into 2D information is proposed, in which a 1D skin pattern sensing module composed of a linearly arranged sensing element array continuously reads 1D near field image information of a skin pattern to be measured. Matched with an algorithm for detecting the relative speed of the continuous 1D information, 2D information of the skin pattern can be obtained.

### BACKGROUND OF THE INVENTION

1. Field of the Invention

The present invention relates to an algorithm for rebuilding 1D information acquired when an object to be measured makes a motion relative to an image input device into 2D information and, more particularly, to an algorithm used when an object to be measured is a skin pattern and an image input device thereof.

2. Description of Related Art

Fingerprint reading methods and devices are more and more appreciated in recent years. In practical life, because the fingerprint recognition technology has become more and more mature, its applications are more and more widespread. For example, the fingerprint recognition technology has early applied in private entrance guard and security systems or in large fingerprint recognition systems of specific organizations. Recently, it has been applied in identity recognition systems of entry and exit control organizations and household registration organizations. Along with gradual popularity of portable electronic devices, there have been some portable electronic products such as mobile phones or personal digital assistants (PDAs) that have adopted this technology.

A conventional skin pattern reading method utilizes a skin pattern sensor composed of capacitive sensors arranged in a 2D array. Its advantage is that users need not to wait for a relative motion generated between a skin pattern to be measured and the sensing module. It is only necessary to directly contact the skin pattern with the sensor to get lumpy 2D image information of the skin pattern. This method, however, has the problem that the electrostatic protection capacity of the capacitive sensor is bad to cause a too low production yield. Moreover, the capacitive sensor is easily damaged by electrostatic charges during usage. Besides, because the 2D sensor has a large area, it is not suitable for applications in small-size portable electronic products.

Another conventional skin pattern reading method utilizes a skin pattern sensor having an optical sensing module composed of sensing elements arranged in a 2D array. The optical 2D sensing module comprises a light source, a light guide (reflector, lens, diffuser, and so on), an optical window (transparent sheet, prism, and son on), an optical imager (aperture, lens, and so on), and a 2D image sensor. Delicate setup and fine tuning of optical path are required for the light source, the light guide, the optical window, and the optical imager, hence having a higher cost. Moreover, the occupied volume is too large to be suitable for integration into portable electronic products.

U.S. Pat. No. 6,381,347 disclosed an optical 2D image sensing device shown in FIG. 1. The optical image sensing device comprises a transparent glass prism 21a, a lens set 22a, an image sensing element 23a, and a light source 24a. The transparent glass prism 21a has an image plane 211a for direct contact with a finger 1a and a sensing plane 212a directly attached to the light source 24a. The lens set 22a and the image sensing element 23a are disposed at a predetermined distance below the sensing plane 212a. Although this optical 2D image sensing device has already overcome the space utilization problem between the light source 24a and the lens 21a, the size of the prism 21a itself cannot be shrunk, and the space occupied by the lens set 22a and the sensing element 23a cannot be saved.

Yet another conventional skin pattern reading method utilizes a 1D band type skin pattern sensor with a width of generally more than 4 rows. The generally adopted width is 8, 12, or 16 rows. It is necessary for users to generate a relative motion between a skin pattern to be measured and the 1D band type skin pattern sensor to acquire continuous 1D band type information for rebuilding 2D information of the skin pattern. This 1D band type skin pattern sensor occupies a less area than that occupied by the above 2D sensors and thus has the opportunity of being integrated into portable electronic products. The common 1D band type sensors are of thermal sensing type, capacitive type, and optical type. Thermal sensing type sensors cannot touch a skin pattern for a too long time. That is, the relative motion between the skin pattern and the thermal sensing type sensor cannot be too slow to lose spatial resolution of the thermal sensing type sensor owing to thermal conductance. On the other hand, the relative motion between the skin pattern and the thermal sensing type sensor cannot be too fast to generate artifact due to thermal effect caused by fast friction, hence affecting the imaging quality. The drawbacks of the capacitive type sensors are described above. Because the optical type sensors still required optical machinery for lighting and imaging, the shrinkage of their size is limited. In summary, although 1D band type sensors are superior to the above 2D sensors in size, area, and cost, they can be further improved.

Still yet another conventional skin pattern reading method utilizes a 1D band type skin pattern sensor with a width of less than 4 rows (e.g., 2 or 3 rows of optical sensors). In this method, optical machinery for lighting, light guiding, and imaging is still required to occupy a large volume. Moreover, the algorithm adopted by this method for rebuilding 1D information into 2D information bases on the similarity between the information obtained by each row of sensors at a certain time and the information obtained by other rows of sensors at a different time to determine the speed of the skin pattern. The rebuilding quality of the 2D information depends strongly on the uniformity and similarity of each sensing element of each row of sensors. Because of manufacturing factors, there is still slight difference between the characteristics of each sensing element of each row of sensors. Added with the factors of optical machinery for lighting, light guiding, and imaging, the total difference of characteristics between each sensing element of each row of sensors becomes larger, hence affecting the rebuilding quality of 2D information. An extra pre-calibration can be used to compensate the above difference in characteristics, but the pre-calibration requires optical machinery for lighting and imaging to occupy some space. In summary, although this skin pattern reading method has a smaller area and a lower cost of sensor than those of the above 1D band type skin pattern reading method, it also can be further improved.

### SUMMARY OF THE INVENTION

An object of the present invention is to provide an algorithm for rebuilding 1D information into 2D information and a 1D skin pattern sensing module thereof, which rebuild 1D linear image into recognizable and high-precision 2D planar image.

Another object of the present invention is to provide an algorithm for rebuilding 1D information into 2D information and a 1D skin pattern sensing module thereof, which make use of primary 1D sensing elements matched with secondary sensing elements to rebuild good-quality images without being affected by the problem of sensitivity uniformity of the sensing elements.

Another object of the present invention is to provide an algorithm for rebuilding 1D information into 2D information and a 1D skin pattern sensing module thereof, which simplify a 2D planar image sensor to a 1D linear sensor. Matched with the relative speed information between the sensor and a skin pattern to be measured, a 2D image can be rebuilt with a reduced size and a lower cost. The 1D skin pattern sensing module is therefore more suitable for applications in personal mobile electronic products, and its competitiveness in the market can be enhanced.

Another object of the present invention is to provide an algorithm for rebuilding 1D information into 2D information and a 1D skin pattern sensing module thereof, in which the light guiding part and the optical imaging part that occupy most volume of a 2D image sensing device are saved, and the skin pattern is directly imaged onto sensing elements based on the near field principle. Therefore, the volume can be shrunk to apply to personal mobile electronic products.

Another object of the present invention is to provide an algorithm for rebuilding 1D information into 2D information and a 1D skin pattern sensing module thereof, in which the 1D skin pattern sensing module comprises a primary 1D sensing element array and a secondary sensing element set to improve the drawback of a 2D sensor array that has a higher cost and occupies a larger area. The skin pattern is directly imaged onto sensing elements by means of near field imaging to improve the light guiding part and the optical imaging part that occupy most volume of a common optical sensor. The time relationship between 1D information obtained by part of the sensing elements of the primary 1D sensing element array and the sensing elements of the secondary sensing element set at continuous and specific intervals is utilized to determine the speed of the skin pattern, thereby rebuilding 2D information of the skin pattern.

The present invention provides an algorithm for rebuilding 1D information obtained by a 1D skin pattern sensing module into 2D information. The algorithm comprises:

providing a 1D skin pattern sensing module comprising a substrate, a 1D skin pattern sensing array set disposed on the substrate, a transparent film covering on the 1D skin pattern sensing array set, an operational unit, and a light source, the 1D skin pattern sensing array set comprising:
a primary 1D sensing element array composed of a plurality of continuous and linearly arranged sensing elements p1, p2, p3, . . . pN to capture 1D skin pattern information; and
a secondary sensing element set composed of at least one or more than one sensing elements s1, s2, . . . sN, and the sensing elements s1, s2, . . . sM being not collinear with a long axis of the primary 1D sensing element array, the set of sensing elements s1, s2, . . . sN being vertically aligned with corresponding sensing elements ps1, ps2, . . . psM in the primary 1D sensing element array with predetermined distances d1, d2, . . . dM in the direction perpendicular to the primary 1D sensing element array, respectively, the sensing elements ps1, ps2, . . . psM being included in the set of the sensing elements p1, p2, . . . pN, the predetermined distances d1, d2, . . . dM being equal to one another or not;
whereby a relative vertical motion is generated between the direction of the long axis of the primary 1D skin pattern sensing module and a skin pattern to be measured to capture 1D information of the skin pattern at continuous and specific intervals;

providing the operational unit to rebuild the 1D information obtained by the 1D skin pattern sensing module into 2D information, the operation of the operational unit comprising:
(i) storing information s1(k), s2(k), . . . sM(k) captured by the sensing elements of the secondary sensing element set in turn and storing information p1(k), p2(k), . . . pN(k) captured by the sensing elements of the primary 1D sensing element array based on continuous sampling timing of the 1D skin pattern sensing module during the period of relative vertical motion of the skin pattern, where k=1, 2, 3, . . . ;
(ii) selecting a section of data with a length of L from the captured information to shift according to the timing the set of at least a piece of information si(l) or more than one pieces of information si(l), sj(1), . . . among s1(l), s2(l), . . . sM(l) and the set of pi(l) or psi(l), psj(l) respectively in alignment with si(l) or si(l), sj(l) among ps(l), ps2(l), . . . psM(l), grouping two sets of data with the same parameter as a pair and then comparing the similarity between each pair in each shift (the commonly used comparison method is the mean-square error sense method, but the present invention is not limited to this method), where l is a parameter of the data length L, and t is a start timing ordinal for each time of comparison, l=t+1, t+2, . . . t+L,;
(iii) obtaining a relative motion speed between the 1D skin pattern sensing module and the skin pattern at the timing t according to a number of shift times, m, that makes the similarity the highest (i.e., the corresponding timing interval) and distances between the secondary sensing elements and the primary 1D sensing elements for comparison (the value of L is selected based on the range of possible speed of the skin pattern, and the maximum possible value of m is much smaller than L, a suggested maximum value of m is L/4, and the suggested comparison length after shift is L/2); and
(iv) successively increasing the timing ordinal t and repeating steps (i) to (iii) to acquire the relative motion speed between the 1D skin pattern sensing module and the skin pattern in each determination interval, and rebuilding 2D information of the skin pattern according to the speed information and the 1D information p1(k), p2(k), . . . pN(k) captured by the sensing elements of the primary 1D sensing element array.

The present invention provides an algorithm for rebuilding 1D information into 2D information and a 1D skin pattern sensing module thereof. The 1D skin pattern sensing module detects information of the skin pattern by means of near field imaging to shrink the volume. The algorithm can prevent the quality of 2D information from being affected by the problem of sensitivity uniformity of the sensing elements. In other words, the present invention provides an algorithm that is barely affected by the problem of sensitivity uniformity of the sensing elements and a sensing module of small size and low cost to apply to portable electronic products, increase the functions of product, and enhance the competitiveness of product.

### BRIEF DESCRIPTION OF THE DRAWINGS

The various objects and advantages of the present invention will be more readily understood from the following detailed description when read in conjunction with the appended drawing, in which:

FIG. 1 is a perspective view of a conventional 2D image sensing device;

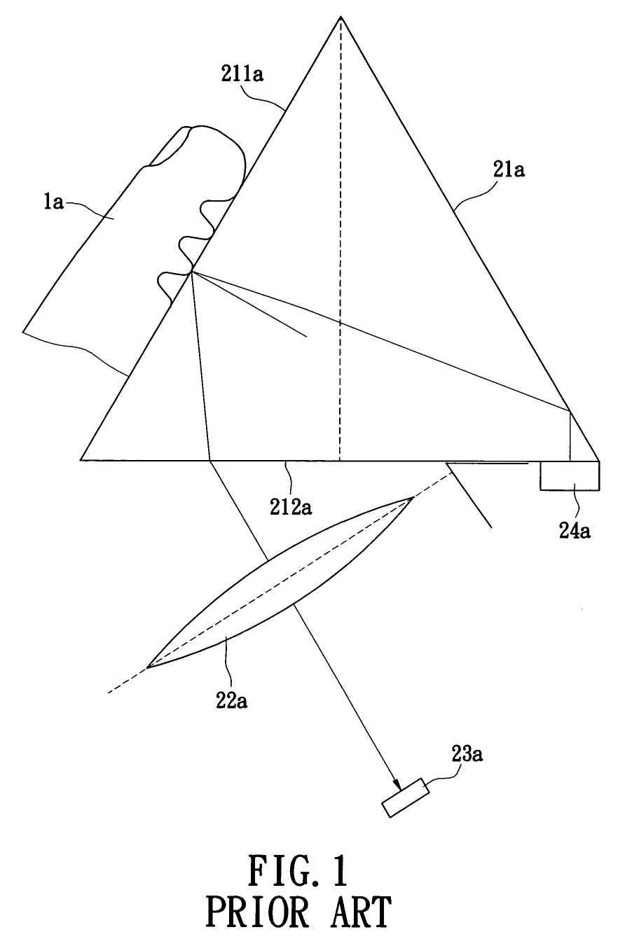

FIG. 2A is an operational diagram of a 1D skin pattern reading module of the present invention;

FIG. 2B is a diagram showing how to access sensing elements in an algorithm for rebuilding 1D information into 2D information of the present invention; and

FIG. 3 is a flowchart of an algorithm for rebuilding 1D information into 2D information of the present invention.

### DETAILED DESCRIPTION OF THE PREFERRED EMBODIMENTS

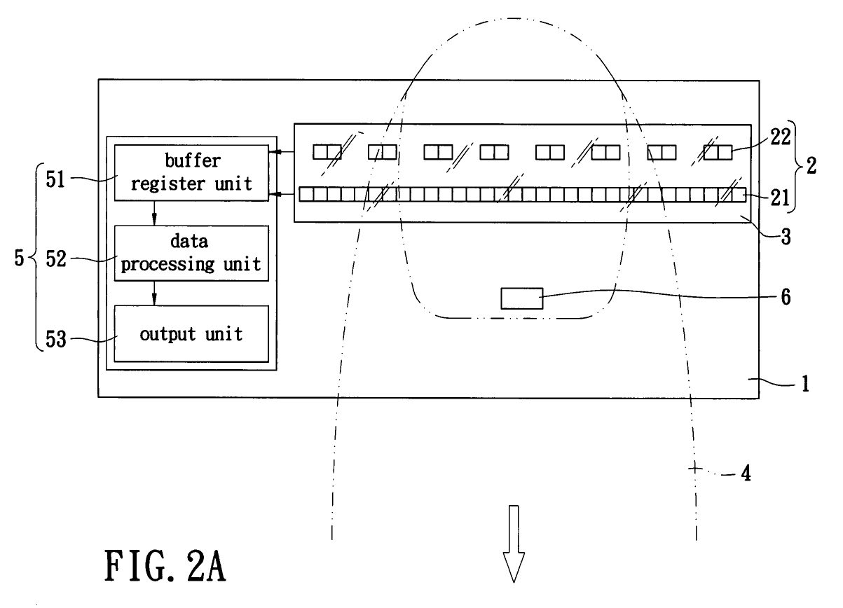

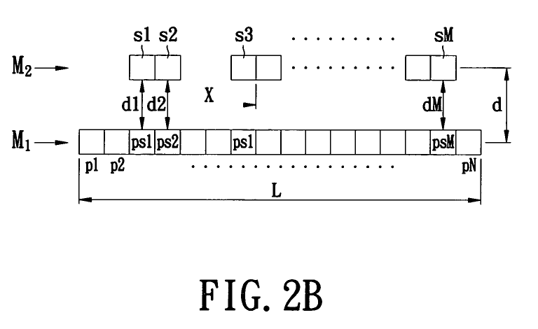

The present invention provides an algorithm and a 1D skin pattern sensing module thereof. The 1D skin pattern sensing module shown in FIG. 2A comprises a substrate 1, a 1D skin pattern sensing array set 2 composed of a plurality of sensing elements that are linearly arranged and disposed on the substrate 1, a transparent film 3 covering on the 1D skin pattern sensing array set 2, an operational unit 5, and a light source 6. As shown in FIG. 2B, the 1D skin pattern sensing array set 2 comprises a primary 1D sensing element array 21 and a secondary sensing element set 22. The primary 1D sensing element array 21 is composed of a plurality of continuous and linearly arranged sensing elements p1, p2, p3, . . . pN to capture 1D skin pattern information. The secondary sensing element set 22 is composed of at least one or more than one sensing elements s1, s2, . . . sN, and the sensing elements s1, s2, . . . sM are not collinear with a long axis of the primary 1D sensing element array 21. The set of sensing elements s1, s2, . . . sN are adjacent to one another or not, and are vertically aligned with corresponding sensing elements ps1, ps2, . . . psM in the primary 1D sensing element array 21 with predetermined distances d1, d2, . . . dM in the direction perpendicular to the primary 1D sensing element array 21, respectively. The sensing elements ps1, ps2, . . . psM are included in the set of the sensing elements p1, p2, . . . pN. The predetermined distances d1, d2, . . . dM being equal to one another or not. In this embodiment, d1=d2=. . . =dM=d. The 1D skin pattern sensing array set 2 is used as an optoelectronic conversion element to convert photons from a skin pattern 4 to be measured into an electric signal. The 1D skin pattern sensing array set 2 can be manufactured by the charge-coupled device (CCD) process or the complementary metal-oxide-semiconductor (CMOS) process.

The skin pattern 4 directly contacts the transparent film 3, and makes a vertical motion relative to the long axis of the 1D skin pattern sensing array set 2. The 1D skin pattern sensing array set 2 thus acquires continuous 1D information of the skin pattern 4 by means of near field imaging though the transparent film 3. The transparent film 3 can provide the functions of etch resistance, scrape resistance, contamination resistance, sufficient light transmission, and protection of the 1D skin pattern sensing array set 2. Besides, the transparent film 3 has a thickness smaller than 1 mm so that the skin pattern 4 and the 1D skin pattern sensing array set 2 can be as close as possible. The present invention needs no optical elements such as prism, lens, and reflector, and delicate setup and fine tuning of optical path are therefore not required. Moreover, because a linear sensing element array is adopted, the whole size can be reduced, and the cost can be lowered.

As shown in FIG. 2A, the operational unit 5 at least comprises a buffer register unit 51, a data processing unit 52, and an output unit 53. The operational unit 5 can be designed in the same semiconductor IC with the 1D skin pattern sensing array set 2, or can be electrically connected with the 1D skin pattern sensing array set 2 on the substrate 1. The buffer register unit 51 temporarily stores information captured by the sensing elements of the primary 1D sensing element array 21 and the secondary sensing element set 22 and other data that should be stored temporarily during the operational process. The data processing unit 52 is used to execute the algorithm for rebuilding 1D information into 2D information. The output unit 53 is used to output the rebuilt 2D information. Moreover, the 1D skin pattern sensing module further comprises an electrostatic protection device connected to the sensing elements. The electrostatic protection device can be designed in the same semiconductor IC with the 1D skin pattern sensing array set 2, or can be disposed on the substrate 1.

The 1D skin pattern sensing module provided by the present invention can utilize a light source 6 disposed on the substrate 1 or an external light source (e.g., sunlight, indoor lamp) not disposed on the substrate 1 for lighting of the skin pattern 4. The light source, however, ought to provide uniform and stable photons incident to the skin pattern 4. In this embodiment, the light source is disposed on the substrate 1 to be projected onto the skin pattern 4 with a predetermined height and a predetermined angle. The predetermined height and angle can be adjusted to match the position where the 1D skin pattern sensing array set 2 is placed on the substrate. A filtering film with a wavelength characteristic corresponding to the light source can be coated onto the 1D skin pattern sensing array set 2 to increase the signal to noise ratio so as to enhance the resistance to outside light pollution. The 1D skin pattern sensing module can further comprise a polarizer, a waveplate, a diffuser, or a reflector, or a predetermined assembly of the above components between the light source 6 and the skin pattern 4. In order to have a larger penetration depth for bio-tissues, red light and near infrared light of wavelength of 650 to 1300 nm can be selected.

When the present invention operates, the skin pattern 4 tightly presses close to the transparent film 3, and makes a vertical motion relative to the 1D skin pattern sensing array set 2 to acquire continuous 1D information of skin pattern at specific intervals. Matched with the algorithm for rebuilding 1D information into 2D information, the 2D information of the skin pattern 4 can be obtained intact.

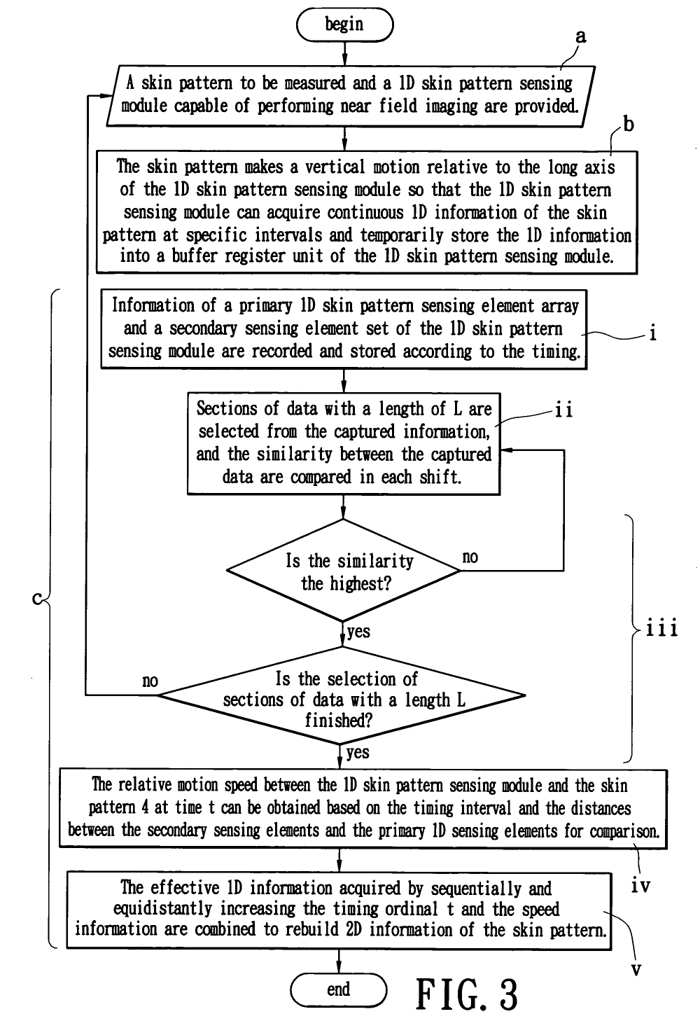

FIG. 3 is a flowchart of an algorithm for rebuilding 1D information into 2D information of the present invention. The algorithm comprises the steps of (a) providing the skin pattern 4 and the 1D skin pattern sensing module capable of performing near field imaging; (b) the skin pattern 4 making a motion relative to the long axis of the 1D skin pattern sensing module so that the 1D skin pattern sensing module can acquire continuous 1D information of the skin pattern 4 at specific intervals and temporarily store the 1D information into the buffer register unit 51 of the operational unit 5; and (c) the operational unit 52 carrying out the following steps:
(i) storing information s1(k), s2(k), . . . sM(k) captured by the sensing elements of the secondary sensing element set 22 in turn and storing information p1(k), p2(k), . . . pN(k) captured by the sensing elements of the primary 1D sensing element array 21 based on continuous sampling timing of the 1D skin pattern sensing module during the period of relative vertical motion of the skin pattern 4, where k=1, 2, 3, . . . representing the timing ordinal;
(ii) selecting a section of data with a length of L from the captured information to shift according to the timing the set of at least a piece of information si(l) or more than one pieces of information si(l), sj(l), . . . among s1(l), s2(l), . . . sM(l) and the set of pi(l) or psi(1), psj(1) respectively in alignment with si(1) or si(1), sj(1) among ps1(l), ps2(l), . . . psM(l), grouping two sets of data with the same parameter as a pair and then comparing the similarity between each pair in each shift (the commonly used comparison method is the mean-square error sense method, but the present invention is not limited to this method), where l is a parameter of the data length L, and t is a start timing ordinal for each time of comparison, l=t+1, t+2, . . . t+L,;
(iii) obtaining a relative motion speed between the 1D skin pattern sensing module and the skin pattern 4 at the timing t according to a number of shift times, m, that makes the similarity the highest (i.e., the corresponding timing interval) and a distance between the secondary sensing elements and the primary 1D sensing elements for comparison (the value of L is selected based on the range of possible speed of the skin pattern, and the maximum possible value of m is much smaller than L, a suggested maximum value of m is L/4, and the suggested comparison length after shift is L/2, the suggested mean-square error sense formula is:

$$Min \{ \{ {\sum }_{I = L / 4 - 1}^{3 L / 4} {\{ si [ l + m ] - pi [ l ] \}}^{2} \} / ( L / 2 ) \} for 0 < m < L / 4 ) ; and$$
(iv) successively increasing the timing ordinal t and repeating steps (i) to (iii) to acquire the relative motion speed between the 1D skin pattern sensing module and the skin pattern 4 in each determination interval, and rebuilding 2D information of the skin pattern 4 according to the speed information and the 1D information p1(k), p2(k), . . . pN(k) captured by the sensing elements of the primary 1D sensing element array 21.

To sum up, the present invention provides an algorithm for rebuilding 1D information into 2D information and a 1D skin pattern sensing module thereof to accomplish the following effects:
(1) 1D linear skin pattern information can be rebuilt into recognizable, high-precision 2D skin pattern information by using the proposed algorithm.
(2) The light guiding part and the optical imaging part that occupy most volume of a 2D image sensing device are saved, and the skin pattern is directly imaged onto the sensing elements by means of near field imaging to shrink the volume.
(3) A 2D planar skin pattern sensor is simplified to a 1D linear skin pattern sensor. Matched with the relative motion between the sensor and the skin pattern, a 2D image can be rebuilt with a reduced size and a lower cost. The 1D skin pattern sensing module is therefore more suitable for applications in personal mobile electronic products, and its competitiveness in the market can be enhanced.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

What is claimed is:

1. An algorithm for rebuilding 1D information obtained by a 1D skin pattern sensing module into 2D information comprising:
providing a 1D skin pattern sensing module composed of a plurality of linearly arranged skin pattern sensing elements, said 1D skin pattern sensing module comprising:
a primary 1D sensing element array composed of a plurality of continuous and linearly arranged sensing elements p1, p2, p3, pN to capture 1D skin pattern information; and
a secondary sensing element set composed of at least one or more than one sensing elements s1, s2, sN, and said sensing elements s1, s2, sM being not collinear with a long axis of said primary 1D sensing element array, said set of sensing elements s1, s2, sN being vertically aligned with corresponding sensing elements ps1, ps2, psM in said primary 1D sensing element array with predetermined distances d1, d2, dM in the direction perpendicular to said primary 1D sensing element array, respectively, said sensing elements ps1, ps2, psM being included in the set of said sensing elements p1, p2, pN;
whereby a relative vertical motion is generated between the direction of said long axis of said primary 1D skin pattern sensing module and a skin pattern to be measured to capture said 1D information;
providing an operational unit to rebuild said 1D information obtained by said 1D skin pattern sensing module into 2D information, the operation of said operational unit comprising the steps of:
(i) storing information s1(k), s2(k), sM(k) captured by said sensing elements of said secondary sensing element set and storing information p1(k), p2(k), pN(k) captured by said sensing elements of said primary 1D sensing element array based on continuous sampling timing of said 1D skin pattern sensing module during the period of relative vertical motion of said skin pattern, where k=1, 2, 3, ;
(ii) selecting a section of data with a length of L from said captured information to shift according to timing the set of at least, a piece of information si(l) or more than one pieces of information si(l), sj(l), among s1(l), s2(l), sM(l) and the set of pi(l) or psi(l), psj(l) respectively in alignment with si(1) or si(1), sj(l) among ps1(l), ps2(l), psM(l), and then comparing the similarity between said two sets of data in each shift, where l=t+1, t+2, t+L, and t is a timing ordinal for each time of comparison;
(iii) obtaining a relative motion speed between said 1D skin pattern sensing module and said skin pattern at the timing t according to a number of shift times making the similarity the highest (i.e., the corresponding timing interval) and a distance between said secondary sensing elements and said primary 1D sensing elements for comparison; and
(iv) successively increasing the timing ordinal t and repeating steps (i) to (iii) to acquire the relative motion speed between said 1D skin pattern sensing module and said skin pattern in each determination interval, and rebuilding 2D information of said skin pattern according to said speed information and said 1D information p1(k), p2(k), pN(k) captured by said sensing elements of said primary 1D sensing element array.

2. The algorithm as claimed in claim 1, wherein said operational unit at least comprising:
a buffer register unit for temporarily storing information captured by said sensing elements of said primary 1D sensing element array and said secondary sensing element set;
a data processing unit for executing the algorithm for rebuilding 1D information captured by said sensing elements of said primary 1D sensing element array and said secondary sensing element set into 2D information; and
an output unit for outputting said rebuilt 2D information.

3. The algorithm as claimed in claim 1, wherein said buffer register unit is designed in the same semiconductor IC with said data processing unit and said output unit.

4. The algorithm as claimed in claim 1, wherein said buffer register unit is placed on an external substrate and then electrically connected to said data processing unit and said output unit.

5. The algorithm as claimed in claim 1, wherein said operational unit is designed in the same semiconductor IC with said sensing elements of said 1D skin pattern sensing module.

6. The algorithm as claimed in claim 1, wherein said operational unit and said sensing elements of said 1D skin pattern sensing module are electrically connected on a substrate.

7. The algorithm as claimed in claim 1, wherein said data processing unit is realized with a procedural language.

8. The algorithm as claimed in claim 1, wherein said 1D skin pattern sensing module comprises:
a substrate;
a 1D skin pattern sensing array set disposed on said substrate and composed of a plurality of linearly arranged sensing elements;
a transparent film covering on said 1D skin pattern sensing array set; and
a light source for operation of said sensing elements.

9. The algorithm as claimed in claim 8, wherein said 1D skin pattern sensing array set comprises:
a primary 1D sensing element array composed of a plurality of continuous and linearly arranged sensing elements p1, p2, p3, pN to capture 1D skin information; and
a secondary sensing element set composed of at least one or more than one sensing elements s1, s2, sM, said sensing elements s1, s2, sM being not collinear with a long axis of said primary 1D sensing element array, said sensing elements s1, s2, sM being vertically aligned with corresponding sensing elements ps1, ps2, psM in said primary 1D sensing element array with predetermined distances d1, d2, . . . dM in the direction perpendicular to said primary 1D sensing element array, respectively, said sensing elements ps1, ps2, . . . psM being included in the set of said sensing elements p1, p2, . . . pN.

10. The algorithm as claimed in claim 8, wherein said light source is an external environmental light source used for lighting of said skin pattern.

11. The algorithm as claimed in claim 8, wherein said light source is disposed on said substrate to be projected onto said skin pattern with a predetermined height and a predetermined angle.

12. The algorithm as claimed in claim 8, wherein said light source is a narrow band light source or a wide band light source attached with a narrow band filtering film.

13. The algorithm as claimed in claim 8, further comprising a polarizer, a waveplate, a diffuser, or a reflector, or a predetermined assembly of the above components between said light source and said skin pattern.

14. The algorithm as claimed in claim 8, wherein said transparent film on said sensing elements is a filtering film, an antireflection film, an analyzer film, or/and a microlens array.

15. A 1D skin pattern sensing module matched with the algorithm as claimed in claim 1, said 1D skin pattern sensing module being able to make a motion relative to a skin pattern to be measured and provide 1D information of said skin pattern for rebuilding 2D information of said skin pattern, said 1D skin pattern sensing module comprising:
a substrate;
a 1D skin pattern sensing array set disposed on said substrate and composed of a plurality of linearly arranged sensing elements;
a transparent film covering on said 1D skin pattern sensing array set; and
a light source for operation of said sensing elements.

16. The 1D skin pattern sensing module as claimed in claim 15, wherein said 1D skin pattern sensing array set comprises:
a primary 1D sensing element array composed of a plurality of continuous and linearly arranged sensing elements p1, p2, p3, pN to capture 1D skin information; and
a secondary sensing element set composed of at least one or more than one sensing elements s1, s2, sM, said sensing elements s1, s2, sM being not collinear with a long axis of said primary 1D sensing element array, said sensing elements s1, s2, sM being vertically aligned with corresponding sensing elements ps1, ps2, psM in said primary 1D sensing element array with predetermined distances d1, d2, dM in the direction perpendicular to said primary 1D sensing element array, respectively, said sensing elements ps1, ps2, psM being included in the set of said sensing elements p1, p2, pN.

17. The 1D skin pattern sensing module as claimed in claim 15, wherein said light source is an external environmental light source used for lighting of said skin pattern.

18. The 1D skin pattern sensing module as claimed in claim 15, wherein said light source is disposed on said substrate to be projected onto said skin pattern with a predetermined height and a predetermined angle.

19. The 1D skin pattern sensing module as claimed in claim 15, wherein said light source is a narrow band light source or a wide band light source attached with a narrow band filtering film.

20. The 1D skin pattern sensing module as claimed in claim 15, further comprising a polarizer, a waveplate, a diffuser, or a reflector, or a predetermined assembly of the above components between said light source and said skin pattern.

21. The 1D skin pattern sensing module as claimed in claim 15, wherein said transparent film on said sensing elements is a filtering film, an antireflection film, an analyzer film, or/and a microlens array.
